(19) United States
(12) Patent Application Publication
(10) Pub. No.: US 2020/0410447 A1
(43) Pub. Date: Dec. 31, 2020

(54) LANGUAGE MANAGEMENT IN AUTOMATED TOOL CONTROL SYSTEMS

(71) Applicant: Snap-on Incorporated, Kenosha, WI (US)

(72) Inventors: David C. FLY, Maumelle, AR (US); Matthew J. LIPSEY, Sherwood, AR (US); Preston C. PHILLIPS, Conway, AR (US); Jason NEWPORT, Conway, AR (US); Andrew R. LOBO, Wadsworth, IL (US); Joseph CHWAN, Mechanicsburg, PA (US); Frederick J. ROGERS, North Little Rock, AR (US); Sean W. RYAN, Pleasant Prairie, WI (US)

(21) Appl. No.: 16/915,807

(22) Filed: Jun. 29, 2020

Related U.S. Application Data
(60) Provisional application No. 62/868,810, filed on Jun. 28, 2019.

(51) Int. Cl. G06Q 10/08; G06F 40/263; G06K 7/10; G06T 7/00

(52) U.S. Cl. CPC G06Q 10/0875; G06T 7/0008; G06K 7/10099; G06F 40/263

(57) ABSTRACT

The present application describes an automated inventory control system that comprises a storage device, an access control device, and a data storage. The storage device includes a plurality of storage locations for storing objects. The access control device is configured to receive user credentials for access to the storage device. The data storage is configured to store configurable parameters associated with the storage device in a plurality of languages, and information corresponding to respective users of the storage device including an assigned language. In response to the access control device receiving user credentials by the access control device, the storage device is configured to obtain configurable parameters from the data storage.

### CROSS-REFERENCE TO RELATED APPLICATION

This application claims the benefit of U.S. Provisional Application No. 62/868,810, filed on Jun. 28, 2019, in the U.S. Patent and Trademark Office, the disclosure of which is incorporated by reference herein in its entirety.

### TECHNICAL FIELD

The present subject matter relates to automated tool control systems, and to techniques and equipment to automatically configure automated tool control systems based on user identification.

### BACKGROUND

When employees use tools in a manufacturing or service environment, it is important that instructions, guidelines, and warnings related to the use of tools are understood by employees. For instance, in aerospace work environment, it is important to ensure employees' understanding of work instructions, tool selection, safety guidelines, torque settings, system and tool status alerts and warnings to properly maintain aircrafts to safety standards.

Tools may be stored in tool control storage devices. Some tool control storage devices are built with displays and speakers for presenting to employees the tool related information (i.e., work instructions, tool selection, safety guidelines, torque settings, system and tool status alerts and warnings). Some tool control storage devices store text strings, audio files, and video files used for presenting texts on the displays, audible messages through the speakers and video messages using both the displays and speakers.

Some tool control storage devices store text strings, audio files, and video files in a variety of languages so that those texts, audible messages, and video messages may be presented in a variety of languages. Each language may have its own directory including a set of text strings, audio files, and video files. Administrators, using a system administrative client software application, may configure the default language to be used by the tool control storage devices. The default language is configured, for example, per device, group of devices, or work locations. For instance, when a specific language is configured for a tool control storage device, a group of tool control storage devices, or a work location, that tool control storage device and all tool control storage devices in the group or the work location will present text strings, audio files, and video files only from that the directory associated with the specific language. However, if an employee's preferred language is different from the specific language set as the default language configured for the tool control storage device, this may create miscommunications and errors that will negatively impact the maintenance of safety standards. With the ease of individuals moving from a country to another, a group of the automated tool control system may include users of various ethnicities and native languages. Thus, configuring tool control storage device with a specific language per device, a group of users, or work locations may create issues where one or more employees accessing the tool control storage device may not be fluent in the specific language the tool control storage device is configured to. Because of the language barrier, important information may not be fully understood by the employees whose preferred language is different from the default language presented on the tool control storage device.

Some tool control storage devices require language and other parameters be configured prior to their use. For example, when a system administrator remotely reconfigures the default language for a tool control storage device, a tool control storage device, a group of tool control storage devices, or a work location, the power to the tool control storage device or tool control storage devices in the group or the work location must be cycled off and on to complete the reconfiguration of the default language.

Accordingly, there is a need for an improved system that enables the tool control storage devices to seamlessly reconfigure to accommodate employees' individual needs.

### DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

To address the issues described in the Background, automated tool control systems have been developed which automatically reconfigure a tool control storage device to configurations associated with a user identification each time an employee presents an access credential to the tool control storage device. The various systems and methods disclosed herein relate to automated tool control systems used automatically reconfigure a tool control storage device to configurations associated with a user identification.

Reference now is made in detail to the examples illustrated in the accompanying drawings and discussed below.

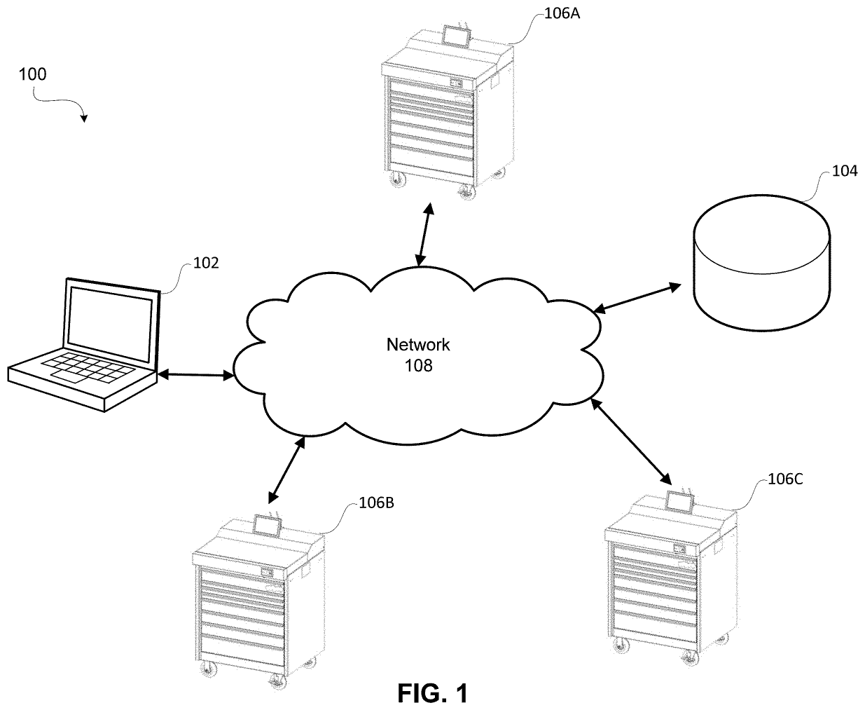

FIG. 1 illustrates an exemplary automated tool control system 100 according to example aspects of the subject technology. The automated control system 100 includes a computing device 102, a database 104, tool control storage devices 106A, 106B, and 106C (hereinafter collectively referred to as “tool control storage devices 106”), and a network 108. In some aspects, the automated control system 100 can have more or fewer computing devices (e.g., 102), databases (e.g., 104), and/or tool control storage devices (e.g., 106A, 106B, and 106C) than those shown in FIG. 1.

The computing device 102 can represent various forms of processing devices that have a processor, a memory, and communications capability. The processor may execute computer instructions stored in memory. The computing device 102 is configured to communicate with the database 104 and the tool control storage devices 106A, 106B, and 106C via the network 108. By way of non-limiting example, processing devices can include a desktop computer, a laptop computer, a handheld computer, a personal digital assistant (PDA), or a combination of any of these processing devices or other processing devices.

The computing device 102 may have applications installed thereon. For example, the applications may include an administrative client software application for controlling and managing the tool control storage devices 106A, 106B, and 106C. The administrative client software application may associate user preferences to a user identification (ID). For example, when a user ID is initially set, the user's preferred language may be assigned to the user ID. The system administrator may assign a specific default language to each user in the automated tool control system. The default language is associated to the user's ID and credentials. The preferred language may be selected from, for example a table and a list of languages provided by the administrative client software application. The preferences, including the preferred language, can be modified. The preferred language associated with the user ID will be used to present information to the user associated with the user ID to ensure the user's understanding of information (e.g., work instructions, tool selection, safety guidelines, torque settings, system and tool status alerts and warnings, etc.) being presented to the user via the tool control device storage devices 106A, 106B, and 106C.

The database 104 is a data storage for storing configurable parameters associated with the user identification (ID). For example, the database 104 may include directories for various languages. Each language may be provided with its own directory that includes sets of text files, audio files, and video files associated with the language. The text files, audio files, and video files may be accessed by the tool control storage devices 106A, 106B, and 106C which may use the configurable parameters stored in the database 104.

The tool control storage devices 106A, 106B, and 106C (hereinafter collectively referred to as “tool control storage devices 106”) are configured to transfer and receive data to and from the database 104 via the network. Data may include configurable parameters, such as text files, audio files, and video files required for configuring the tool control storage devices 106 according to user preferences.

The tool control storage device 106 is a toolbox in some embodiments. The tool control storage devices 106 may more generally be tool lockers or any other secure storage devices or enclosed secure storage areas (e.g., a tool crib or walk-in tool locker). Each of the tool control storage devices 106 is an example of a highly automated inventory control system that utilizes multiple different sensing technologies for identifying inventory conditions of objects in the storage unit. In one example, the tool control storage devices 106 use machine imaging and RF sensing methodologies for identifying inventory conditions of objects in the storage unit.

Illustrative features include the ability to process complex image data with efficient utilization of system resources, autonomous image and camera calibrations, identification of characteristics of tools from image data, adaptive timing for capturing inventory images, efficient generation of reference data for checking inventory status, autonomous compensation of image quality, etc. Further features include the ability to emit and receive RF sensing signals such as RF identification (RFID) signals, to process the received signals to identify particular tools, and to cross-reference tool information obtained through the multiple different sensing modalities (e.g., camera and RFID based modalities) to provide advanced features.

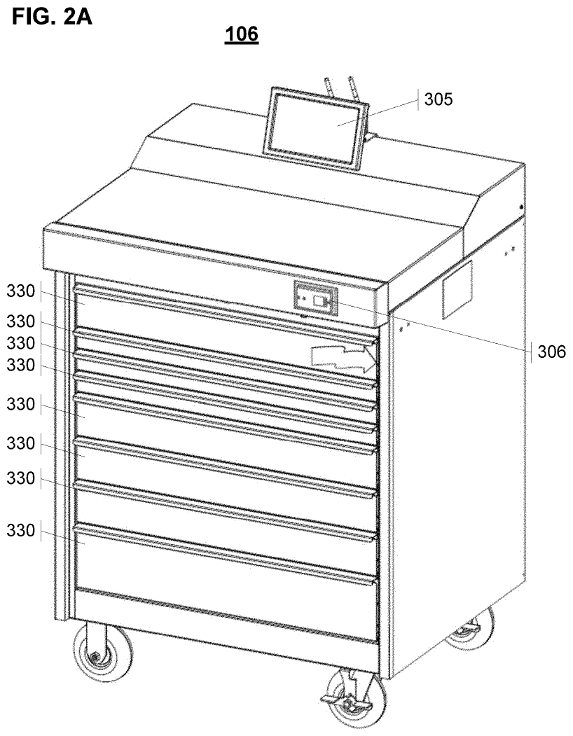

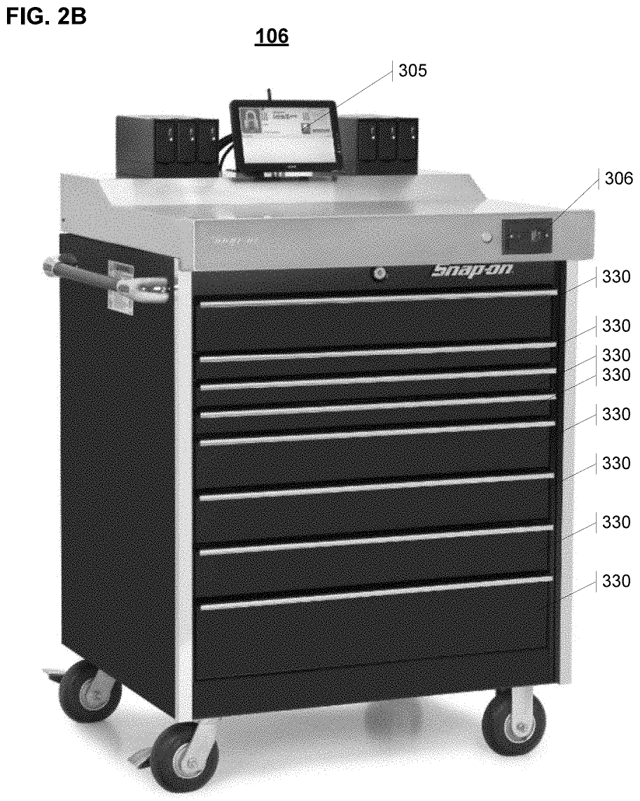

FIGS. 2A and 2B illustrate various exemplary tool control storage devices 106. The tool control storage device 106 includes a user interface 305, an access control device 306, such as a card reader, for verifying identity and authorization levels of a user intending to access tool control storage device 106, and multiple tool storage drawers 330 for storing tools. Instead of drawers 330, the storage system may include shelves, compartments, containers, or other object storage devices from which tools or objects are issued and/or returned, or which contain the storage device from which the objects are issued and/or returned. In further examples, the storage system includes storage hooks, hangers, tool boxes with drawers, lockers, cabinets with shelves, safes, boxes, closets, vending machines, barrels, crates, and other material storage means.

User interface 305 is an input and/or output device of the tool control storage device 106, configured to display information to a user. Information may include work instructions, tool selection, safety guidelines, torque settings, system and tool status alerts and warnings. For instance, the user interface 305 may be configured to display the information in text strings and images in the default language assigned to the user who currently has access to the tool control storage device 106. Although not illustrated in FIGS. 2A and 2B, the tool control storage device 106 may include speakers as another output device of the tool control storage device 106 for outputting the information.

Access control device 306 authenticates a user's authorization for accessing automated tool control system 100. Specifically, access control device 306 is used to limit or allow access to tool storage drawers 330. The methods and systems used to electronically identify the user requesting access may include any one or more of the following technologies, and others not mentioned, individually or in combination: RFID proximity sensors with cards; magstripe cards and scanners; barcode cards and scanners; common access cards and readers; biometric sensor ID systems, including facial recognition, fingerprint recognition, handwriting analysis, iris recognition, retinal scan, vein matching, voice analysis, and/or multimodal biometric systems.

The access control device 306 further includes a processor and software to electronically identify a user requesting access to the secure area or object storage device. For instance, when a user presents the user's credentials to a tool control storage device 106, the access control device 306 recognizes the default language assigned to the user identification. The tool control storage device 106 accesses the language directory associated with the recognized default language in the database 104. The tool control storage device 106 configures the operational code in the tool control storage device 106 to display the text strings, audio files, and video files stored in the tool control storage device 106 according to the language directory associated with the default language of the user. For example, if the tool control storage device 106 is configured to display text, audio, and video messages in Portuguese, the tool control storage device 106 selects the appropriate text strings, audio files, and video files to be displayed from the Portuguese language directory. The same may be true for English, Spanish, Chinese, and other language files loaded in the language directories in the database 104.

This ensures the user's understanding of work instructions, tool selection, safety guidelines, torque settings, system and tool status alerts and warnings that may be presented via the user interface 305 and/or speakers provided on the tool control storage device 106. In some embodiments, unit of measurement (imperial/metric) can also be assigned to user identification and applied to the tool control storage device 106 when the user access credentials are presented to the tool control storage device 106. In some other embodiments, the work orders associated with the user ID, tools associated with the work orders and user ID, and other user (e.g., co-workers) associated with the user ID may be used to configure the tool control storage device 106 when the user logs in using user's credentials.

Access control device 306, through the use of one or more electronically controlled locking devices or mechanisms, keeps some or all storage drawers 330 locked in a closed position until access control device 306 authenticates a user's authorization for accessing tool control storage device 106. If access control device 306 determines that a user is authorized to access tool control storage device 106, it unlocks some or all storage drawers 330, depending on the user's authorization level, allowing the user to remove or replace tools. In particular, the access control device 306 may identify predetermined authorized access levels to the system, and allow or deny physical access by the user to the three dimensional space or object storage devices based on those predetermined authorized levels of access.

Tool control storage device 106 includes several different sensing subsystems. In an illustrative example, the tool control storage device 106 includes a first sensing subsystem in the form of an image sensing subsystem configured to capture images of contents or storage locations of the system. The image sensing subsystem may include lens-based cameras, CCD cameras, CMOS cameras, video cameras, or any types of device that captures images. The tool control storage device 106 further includes a second sensing subsystem that, in one example, takes the form of an RFID sensing subsystem including one or more RFID antennas, RFID transceivers, and RFID processors. The RFID sensing subsystem is configured to emit RF sensing signals, receive RFID signals returned from RFID tags mounted on or incorporated in tools or other inventory items in response to the RF sensing signals, and process the received RFID signals to identify individual tools or inventory items.

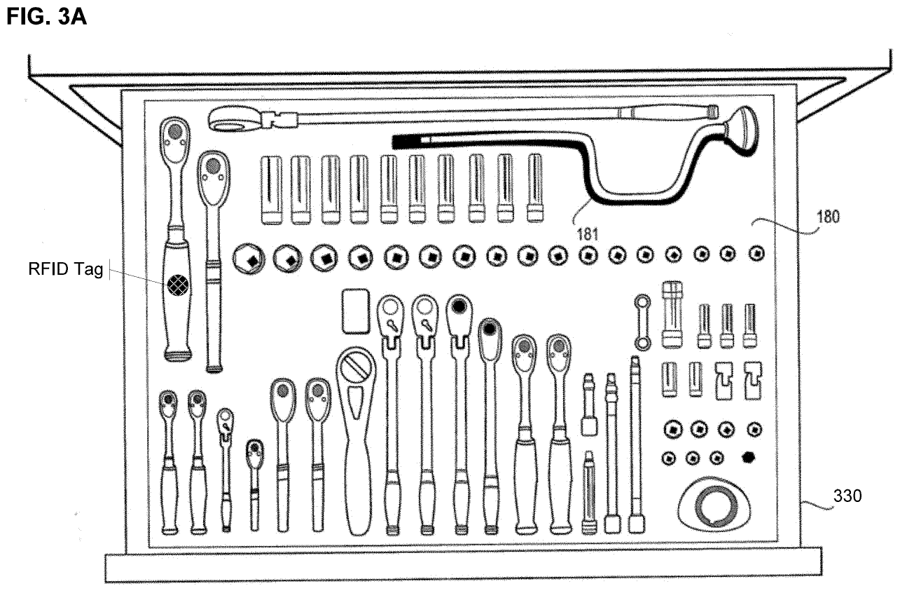

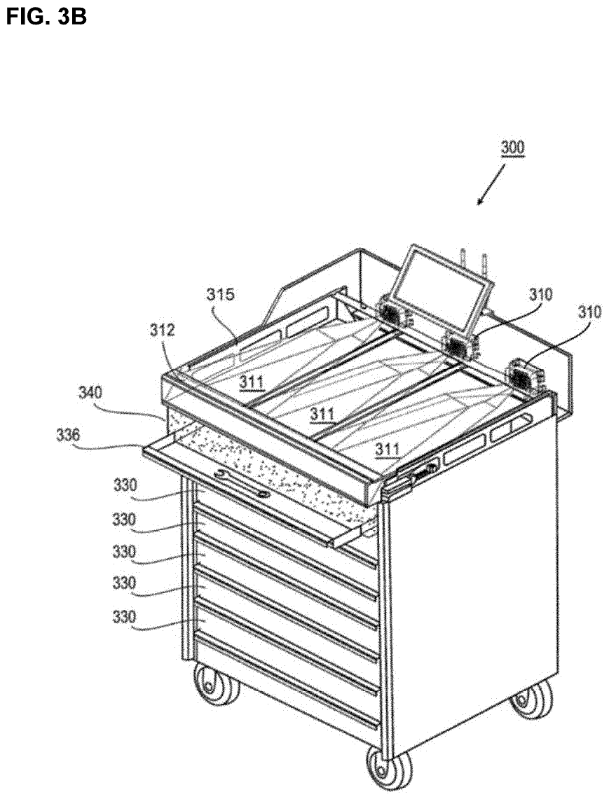

The image sensing subsystem is described in further detail below in relation to FIG. 3B. While FIG. 3B corresponds to the specific embodiment of the tool control storage device 106 shown in FIG. 1C, the teachings illustrated in FIG. 3B can be applied to each of the embodiments of FIGS. 1A-1C. The RFID sensing subsystem may be configured to sense RFID tags of tools located in all storage drawers 330 of tool control storage device 106, or configured to sense RFID tags of tools located in a particular subset of the drawers 330 of tool control storage device 106. In one example, the RFID sensing subsystem is configured to sense RFID tags of tools located only in the top-most and bottom-most drawers 330 of tool control storage device 106, and the RFID sensing subsystem includes RFID antennas disposed directly above the top-most and bottom-most drawers 330 within tool control storage device 106 to sense RFID tags of tools located in those drawers. Other configurations of RFID antennas can also be used.

Tool control storage device 106 further includes a data processing system, such as a computer, for processing images captured by the image sensing device, for processing RFID signals captured by the RFID antennas and transceivers, and/or for processing other sensing signals received by other sensing subsystems. The data processing system includes one or more processors (e.g., micro-processors) and memory storing program instructions for causing the tool control storage device 106 to communicate electronically directly or through a network with sensing devices and obtain data from sensing devices relative to the presence or absence data of objects within the three dimensional space or object storage device. Images, RFID signals, and other sensing signals captured or received by the sensing subsystems are processed by the data processing system for determining an inventory condition of the system or each storage drawer. The term inventory condition as used throughout this disclosure means information relating to an existence/presence or non-existence/absence condition of objects in the storage system.

The data processing system may be part of tool control storage device 106. Alternatively, the data processing system can be a remote computer having a data link, such as a wired or wireless link, coupled to the tool control storage device 106, or a combination of a computer integrated in the tool control storage device 106 and a computer remote from the tool control storage device 106. Additionally, the data processing system can be connected to a computer network and exchange data with an administrative software application (e.g., as may be executed on a server) used to manipulate and store data and store and display information relative to the data to system users.

FIG. 3A shows a detailed view of one drawer 330 of the tool control storage device 106 in an open position. In some embodiments, each storage drawer 300 includes a foam base 180 having a plurality of storage locations, such as tool cutouts 181, for storing tools. Each cutout is specifically contoured and shaped for fittingly receiving a tool with corresponding shapes. Tools may be secured in each storage location by using hooks, Velcro, latches, pressure from the foam, etc.

In general, each storage drawer 330 includes multiple storage locations for storing various types of tools. As used throughout this disclosure, a storage location is a location in a storage system for storing or securing objects. In one embodiment, each tool has a specific pre-designated storage location in the tool storage system. Further, one or more tools in the drawer 330 may have an RFID tag mounted or attached thereon.

FIG. 3B shows a perspective view of an imaging subsystem in tool control storage device 106 according to an embodiment. As illustrated in FIG. 3B, the tool control storage device 106 includes an imaging compartment 315 which houses an image sensing subsystem comprising three cameras 310 and a light directing device, such as a mirror 312 having a reflection surface disposed at about 45 degrees downwardly relative to a vertical surface, for directing light reflected from drawers 330 to cameras 310. The directed light, after arriving at the cameras 310, allows the cameras 310 to form images of the drawers 330. The shaded area 340 below the mirror 312 represents a viewing field of the imaging sensing subsystem of the tool control storage device 106. As shown at 340, the imaging subsystem scans a portion of an open drawer 336 that passes through the field of view of the imaging sensing subsystem, for example as the drawer 336 is opened and/or closed. The imaging subsystem thereby captures an image of at least that portion of the drawer 336 that was opened. Processing of the captured image is used to determine the inventory conditions of tools and/or storage locations in the portion of the drawer 336 that was opened.

In general, the image sensing subsystem captures an image of a particular drawer 330 and performs an inventory of the drawer in response to detecting movement of the particular drawer. For example, the image sensing subsystem may perform an inventory of the drawer in response to detecting that the drawer is closing or has become completely closed. In other examples, the image sensing subsystem may image the drawer both as it is opening and as it closes.

The RF sensing subsystem is generally configured to perform inventory checks of drawers having RF-based tags associated therewith. The RF-based tags may be RFID tags that are attached to or embedded within the tools. In general, the RF-based tag encodes an identifier unique to the tool, such that both the tool type (e.g., screwdriver, torque wrench, or the like) and the unique tool (e.g., a particular torque wrench, from among a plurality of torque wrenches of the model and type) can be identified from reading the RF-based tag. In particular, the information encoded in the RF-based tag is generally unique to the tool such that it can be used to distinguish between two tools that are of a same type, same model, same age, same physical appearance, etc.

The RF sensing system includes antennas mounted in or around the tool control storage device 106. In general, the antennas may be mounted inside the tool control storage device 106 and be configured to only detect the presence of RF-based tags that are located within the tool control storage device 106 (or other defined three dimensional space). In some examples, each antenna may be mounted so as to only detect the presence of RF-based tags that are located within a particular drawer or compartment of the tool control storage device 106, and different antennas may be associated with and mounted in different drawers or compartments. In further embodiments, some antennas may further be configured to detect the presence of RF-based tags in the vicinity of the tool control storage device 106 even if the tags are not located within the tool control storage device 106.

Each antenna is coupled to an RF transceiver that is operative to cause the antenna to emit an RF sensing signal used to excite the RF-based tags located within the vicinity of the antenna, and is operative to sense an RF identification signals returned by the RF-based tags in response to the RF sensing signal. One or more RF processors control the operation of the RF transceivers and process the RF identification signals received through the antennas and transceivers.

In some embodiments, the RF sensing subsystem performs an RF-based scan of the tool control storage device 106 when a drawer or compartment storing tools having RF identification tags is completely closed. In particular, the RF-based scan can be performed in response to detecting that the drawer has been completely closed, or performed at any time when the drawer is completely closed. In some examples, the RF-based scan can also be triggered by a user logging into or logging out of the tool control storage device 106. In general, an RF-based scan can be performed in response to similar triggers causing a camera-based inventory of the tool control storage device 106 to be performed.

As part of performing an RF-based scan of the tool control storage device 106, the RF processor typically needs to perform multiple sequential scans in order to ensure that all RF-based tags are detected. Specifically, the RF processor generally does not know how many RF tags it needs to detect, since one or more tags may be missing (e.g., if a tool has been checked out). Further, the RF processor cannot generally ensure that all RF tags in its vicinity have been detected in response to a single scan operation (corresponding to the emission of one RF sensing signal, and the processing of any RF identification responses received in response to the one RF sensing signal). As a result, the RF processor will generally perform ten, twenty, or more sequential RF-based scans any time an inventory of the tool control storage device 106 is to be performed. Because multiple RF-based scans need to be performed, the RF scanning operation may require 10 or more seconds to be performed, resulting in significant inconvenience to users of the tool control storage device 106.

As noted above, imaging-based inventory scans of the tool control storage device 106 have the disadvantage that they cannot distinguish between physically identical tools. Further, RF-based scans of the tool control storage device 106 may suffer from significant delay, and cannot determine if an RF tag alone (instead of an RF tag attached to its associated tool) has been returned to the drawer or storage compartment. Both scanning methodologies, when used alone, are thus susceptible to fraud (by using a tool cut-out, or using a RFID tag removed from tool) and inconvenience. Further, each technology may not be suitable for inventorying all tools in a particular tool control storage device 106; for example, some tools may be too small to have an RF-based tag mounted thereon, or attaching of such a tag to the tool may cause the tool be unwieldy. The inventory of such tools may thus be better suited to visual-scanning methodologies even in tool control storage devices 106 capable of RF-based sensing.

In order to address the deficiencies of the scanning methodologies when used individually, the tool control storage device 106 advantageously uses multiple scanning methodologies in combination in some embodiments. For example, the tool control storage device 106 may firstly perform a first inventory scan based on an image-based scan to obtain a quick (e.g., near instantaneous) determination of whether any tools are missing from the tool control storage device 106 based on the image-based scan alone. The result of the first inventory scan is additionally used to determine how many RF-based tags are expected to be in the tool control storage device 106. For example, in a tool control storage device 106 that usually stores ‘m’ tools having associated RF tags, the first inventory scan is used to determine that ‘n’ tools having associated RF tags are missing from the tool control storage device 106. The first inventory scan is then used to determine that the ‘m-n’ RF-based tags should be searched for using the second inventory scan (e.g., an RF-based scan).

In turn, the second inventory scan (e.g., an RF-based scan) is performed a single time, and only needs to be repeated if less than ‘m-n’ RF-based tags are detected by the first iteration of the second inventory scan (e.g., the RF-based scan). Thus, the second inventory scan can be completed very efficiently—notably in situations in which only one or a few secondary scans are needed to detect all of the ‘m-n’ RF-based tags that are expected to be detected in the tool control storage device 106.

Finally, an inventory cross-check is performed between the results of the first and second inventory scans to ensure that the results of the two scans are consistent. Specifically, the inventory cross-check is performed to ensure that both inventory scans have identified the same tools as being present in the tool control storage device 106 and have identified the same tools as being absent from the tool control storage device 106. User alerts are issued if the results of the two inventory scans are not consistent with each other.

As noted above, the RF-based scan can be used to identify whether a specific tool (from among multiple similar tools) has been checked out or checked back in to the tool control storage device 106. The RF-based scan can thus be used to determine how many times a particular tool has been checked out, and/or for how long a duration the particular tool has been checked out. The tool control storage device 106 can thus determine whether the particular tool should be scheduled for a re-calibration or other upkeep, for example. In one example, the tool control storage device 106 can thus individually track the usage of different torque wrenches and ensure that each torque wrench is recalibrated after a certain number of uses.

The inventory performed by the tool control storage device 106 using multiple sensing technologies can be used to identify the individual user who received and or returned the object/tool, identify the object/tool which is being issued or returned, place a time stamp on each transaction within the system, and store item and user data in a database.

While the above example has focused on an embodiment using camera-based and RF-based sensing technologies, the automated asset management system can use other combinations of multiple-sensing technologies. The sensing technologies and sensing devices used in the tool control storage device 106 can include one or more of:
Optical identification sensors, such as: sensors for detecting one dimensional barcodes with line scanner/camera; sensors for detecting two dimensional barcodes with camera/other imaging sensor; machine vision identification sensors with camera/other imaging sensor (using various sensing approaches, including UV, infrared (IR), visible light, or the like); and laser scanning;
RF identification sensors, such as: RFID tags affixed to/embedded in tools (active RFID tags and/or passive RFID tags); other RF technologies used in similar capacity, such as Ruby, Zigbee, WiFi, NFC, Bluetooth, Bluetooth lower energy (BLE), or the like;
Direct electronic connection to tool, such as: tools that have attached/embedded connectors that plug into identification system (as opposed to wireless);
Weight sensor(s), such as: scales to detect weight of objects; multiple scales to detect weight distribution;
Contact switches/sensors, such as: single go/no-go sensors; array of sensors to detect shape/outline;
Sonic emitter/detector pair; and/or
Magnetic induction/sensing, such as ferrous tool locator products.

A detailed example of one illustrative embodiment is provided below. In the illustrative embodiment, a physically defined, secure three dimensional object storage device is provided. The storage device is the container from which tools and/or objects are issued and/or returned. The physically defined, secure three dimensional object storage device is equipped with a processor and software operative to cause the device to communicate electronically directly or through a network with sensing devices and to obtain data from sensing devices indicating the presence or absence data of objects within the three dimensional object storage device. In the example, the sensing devices used within the three dimensional object storage device include machine vision identification devices such as cameras and RFID antennas and decoders.

The physically defined, secure three dimensional object storage device is equipped with an electronically controlled locking mechanism, along with an access control device including a processor and software means to electronically identify a user requesting access to the secure area or object storage device. The processor and software identify predetermined authorized access levels to the system, and allow or deny physical access by the user to the three dimensional space or object storage devices based on those predetermined authorized levels of access. The access control device used to electronically identify the user requesting access uses RFID proximity sensors with cards.

The physically defined, secure object storage device is equipped with drawers. At least one RFID antenna is attached inside the storage device and is configured for scanning for RFID tags within the storage device. In embodiments with multiple RFID antennas, different RFID antennas may be distributed throughout the storage device. The processor and memory storing executable software program instructions of the storage device can be connected to a computer network, and can exchange data with an administrative software application (e.g., one executed on a remote server) used to manipulate and store data and store and display information relative to the data to system users.

In operation, a user scans or approaches an access card to the access control device of the storage device. The processor of the access control device determines an access level of the user based on the access card. If the user is determined to be authorized for access to the storage device, the authorized user gains access to the object storage device. In turn, the sensing subsystems and data processing system of the storage device are activated. Light emitting diodes (LEDs) used for providing light to the system are activated, and cameras are activated. In turn, the latch of the storage system is unlocked, and the user opens one or more drawers and removes or returns one or more objects.

Note that if the user opens an imaging-only drawer (i.e., a drawer whose inventory condition is determined using imaging only, and not using RFID), then the RFID scanning subsystem need not be activated and the system can use only imaging data. Specifically, the imaging subsystem is used to optionally image the drawer as it opens and to image the drawer as it is closed (or once it is closed), and object presence and absence is determined using only the captured images.

However, if the user opens a drawer for which RFID scanning is used to determine inventory conditions, a camera-based scan of the drawer is optionally performed prior to or as the drawer opens. Additionally, the RFID sensing subsystem is activated and an RFID scan may be completed prior to opening the drawer to identify all RFID tags present in the storage system (or all RFID tags present in the drawer being opened). Specifically, an RFID scan is optionally performed prior to opening of the drawer. Additionally, a camera-based scan of the drawer is performed as the drawer closes. In response to the drawer being fully closed, or in response to the user logging out of the storage system an RFID scan of the drawer or box is performed. The imaging subsystem thus determines and reports object presence and absence in the drawer, and the RFID subsystem scan confirms presence and absence of the specific objects in the drawer or box using the RFID tag data. Thus, imaging data and RFID tag data are combined to report presence and absence of all scanned tools, plus presence or absence of serialized items through use of RFID data. The inventory scan results are depicted on a display. As the user logs out, object status is transmitted via network to a primary database and/or to an administrative application. LED lights are turned off, the lock is engaged, and cameras are set in idle state.

Additionally, the storage system can perform other actions. For example, the system can activate or initiate an RFID scan on the contents of the object storage device on a scheduled or timed basis between user accesses and thereby confirm that the contents of the storage device have not changed since the last user access.

For example, an automated asset management system, such as a toolbox, may use both camera-based and radio-frequency (RF) based sensing technologies to sense the presence and/or other attributes of a particular tool (or of multiple tools). The camera-based sensing may provide an instantaneous (or near-instantaneous) indication of whether the particular tool is present in or absent from the system. The RF-based sensing may enable the system to differentiate between multiple tools that are identical to the camera-based sensing module (e.g., similar torque wrenches), for example by distinguishing between the tools' serial numbers (or other unique identifiers) or other unique tool identifiers encoded in a RF-based tag. Further, the automated asset management system may be configured to more efficiently perform RF-based sensing by leveraging the combined use of the camera-based and RF-based sensing modalities as described in more detail below.

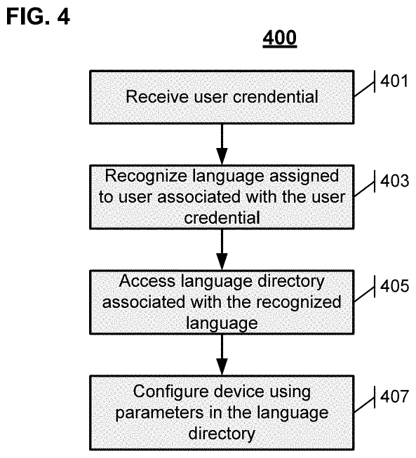

FIG. 4 shows a flowchart illustrating an example process 400 for automatically configuring a tool control storage device 106 according to exemplary aspects of the subject technology. For explanatory purposes, the various blocks of exemplary process 400 are described herein with reference to the components and/or processes described herein. The one or more of the blocks of the process 400 may be implemented, for example, by one or more components or processors of the tool control storage device 106 of FIG. 1. In some implementations, one or more of the blocks may be implemented apart from other blocks, and by one or more different processors or controllers. Further, for explanatory purposes, the blocks of the process 400 are described as occurring in serial, or linearly. However, multiple blocks of the process 400 may occur in parallel. In addition, the blocks of the process 400 need not be performed in the order shown and/or one or more of the blocks of the process 400 need not be performed.

At block 401, the tool control storage device 106 receives a user ID and/or user credential via the access control device 306. At block 403, the tool control storage device 106 recognizes the language assigned to the user associated with the received user credential. For example, the preferred language may be assigned to the user ID at the time of setting up the user ID for the user. At block 405, the tool control storage device 106 accesses the language directory associated with the assigned language in the database 104. At block 407, the tool control storage device 106 configures itself using the parameters, such as text strings, audio files, and video files in the language directory. For example, the tool control storage device 106 configures the operational code in the tool control storage device 106 to present information on the user interface 305 and speakers in the assigned language.

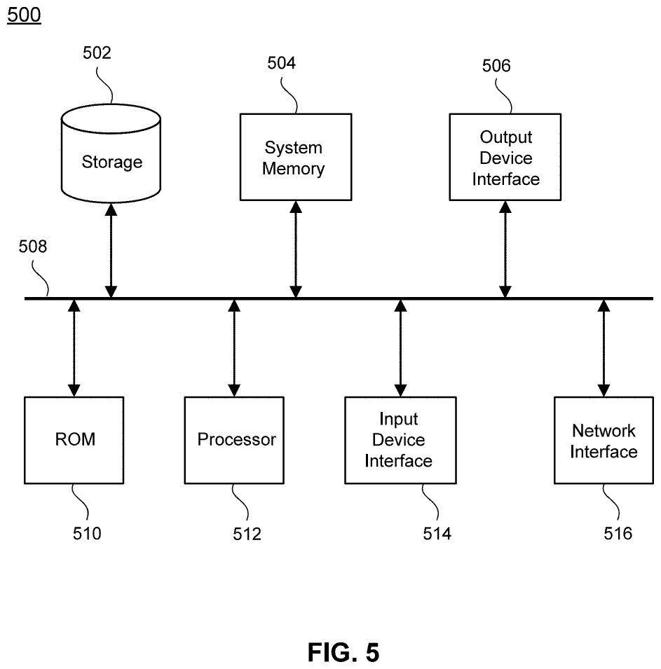

FIG. 5 conceptually illustrates an exemplary electronic system 500 with which some implementations of the subject technology can be implemented. In one or more implementations, the computing device 102 and the tool control storage devices 106 may be, or may include all or part of, the electronic system components that are discussed below with respect to the electronic system 500. The electronic system 500 can be a computer, phone, personal digital assistant (PDA), or any other sort of electronic device. Such an electronic system includes various types of computer readable media and interfaces for various other types of computer readable media. The electronic system 500 includes a bus 508, processing unit(s) 512, a system memory 504, a read-only memory (ROM) 510, a permanent storage device 502, an input device interface 514, an output device interface 506, and a network interface 516.

The bus 508 collectively represents all system, peripheral, and chipset buses that communicatively connect the numerous internal devices of the electronic system 500. For instance, the bus 508 communicatively connects the processing unit(s) 512 with the ROM 510, system memory 504, and permanent storage device 502.

From these various memory units, the processing unit(s) 512 retrieves instructions to execute and data to process in order to execute the processes of the subject disclosure. The processing unit(s) can be a single processor or a multi-core processor in different implementations.

The ROM 510 stores static data and instructions that are needed by the processing unit(s) 512 and other modules of the electronic system. The permanent storage device 502, on the other hand, is a read-and-write memory device. This device is a non-volatile memory unit that stores instructions and data even when the electronic system 500 is off Some implementations of the subject disclosure use a mass-storage device (for example, a magnetic or optical disk, or flash memory) as the permanent storage device 502.

Other implementations use a removable storage device (for example, a floppy disk, flash drive) as the permanent storage device 502. Like the permanent storage device 502, the system memory 504 is a read-and-write memory device. However, unlike the storage device 502, the system memory 504 is a volatile read-and-write memory, such as a random access memory. The system memory 504 stores some of the instructions and data that the processor needs at runtime. In some implementations, the processes of the subject disclosure are stored in the system memory 504, the permanent storage device 502, or the ROM 510. For example, the various memory units include instructions for displaying graphical elements and identifiers associated with respective applications, receiving a predetermined user input to display visual representations of shortcuts associated with respective applications, and displaying the visual representations of shortcuts. From these various memory units, the processing unit(s) 512 retrieves instructions to execute and data to process in order to execute the processes of some implementations.

The bus 508 also connects to the input and output device interfaces 514 and 506. The input device interface 514 enables the user to communicate information and select commands to the electronic system. Input devices used with the input device interface 514 include, for example, alphanumeric keyboards and pointing devices (also called “cursor control devices”). The output device interface 506 enables, for example, the display of images generated by the electronic system 500. Output devices used with the output device interface 506 include, for example, printers and display devices, for example, cathode ray tubes (CRT) or liquid crystal displays (LCD). Some implementations include devices, for example, a touchscreen that functions as both input and output devices.

Finally, as shown in FIG. 5, the bus 508 also couples the electronic system 500 to a network (not shown) through a network interface. In this manner, the computer can be a part of a network of computers (for example, a LAN, a WAN, or an Intranet, or a network of networks, for example, the Internet). Any or all components of the electronic system 500 can be used in conjunction with the subject disclosure.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, magnetic media, optical media, electronic media, etc. The computer readable media does not include carrier waves and electronic signals passing wirelessly or over wired connections.

Unless otherwise stated, all measurements, values, ratings, positions, magnitudes, sizes, and other specifications that are set forth in this specification are approximate, not exact. They are intended to have a reasonable range that is consistent with the functions to which they relate and with what is customary in the art to which they pertain.

Except as stated immediately above, nothing that has been stated or illustrated is intended or should be interpreted to cause a dedication of any component, step, feature, object, benefit, advantage, or equivalent to the public.

In this specification, the term “software” is meant to include, for example, firmware residing in read-only memory or other form of electronic storage, or applications that may be stored in magnetic storage, optical, solid state, etc., which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example, microprocessors, storage, and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra-density optical discs, any other optical or magnetic media, and floppy disks. The computer-readable media can store a computer program that is executable by at least one processing unit and includes sets of instructions for performing various operations. Examples of computer programs or computer code including machine code, for example, produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example, application specific integrated circuits (ASICs) or field programmable gate arrays (FPGAs). In some implementations, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

To the extent that the systems discussed herein collect usage data associated with users, or may make use of the usage data, the users are provided with opportunities to control whether programs or features collect usage data (e.g., a user's preferences), and to control the user interface (UI) associated with applications based on the collected usage data. The users may also be provided with options to turn on or turn off certain features or functions provided by the systems. In some aspects, the users may elect to disable features and functions (e.g., control the UI associated with applications based on the collected usage data) offered by the systems discussed herein. In addition, users may stipulate that certain data be treated in one or more ways before it is stored or used, so that personally identifiable information is removed. For example, a user's identity may be treated so that no personally identifiable information can be determined for the user, or a user's geographic location may be generalized where location information is obtained (such as to a city, zip code, or state level), so that a particular location of a user cannot be determined. Thus, the user has control over whether and how user information is collected, stored, and used by the disclosed systems.

All structural and functional equivalents to the elements of the various aspects described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. Furthermore, to the extent that the term “include”, “have”, or the like is used in the description or the claims, such term is intended to be inclusive in a manner similar to the term “comprise” as “comprise” is interpreted when employed as a transitional word in a claim.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

In the foregoing Description, it can be seen that various features are grouped together in various embodiments for the purpose of streamlining the disclosure. This method of disclosure is not to be interpreted as reflecting an intention that the claimed embodiments require more features than are expressly recited in each embodiment. Rather, inventive subject matter lies in less than all features of a single disclosed embodiment.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended that this disclosure cover any and all applications, modifications and variations that fall within the true scope of the present teachings.

1. An automated inventory control system comprising:
a storage device including a plurality of storage locations for storing objects;
an access control device configured to receive user credentials for access to the storage device;
a data storage configured to store configurable parameters associated with the storage device in a plurality of languages, and information corresponding to respective users of the storage device including an assigned language;
wherein, in response to the access control device receiving user credentials by the access control device, the storage device is configured to obtain configurable parameters from the data storage.

2. The automated inventory control system of claim 1, wherein the configurable parameters from the data storage are in the assigned language corresponding to the user.

3. The automated inventory control system of claim 1, wherein the configurable parameters include text files, audio files, and video files in a plurality of languages.

4. The automated inventory control system of claim 1, further comprising:
a display associated with the storage device,
wherein the configurable parameters includes display information comprising one or more of: work instructions, tool selection, safety guidelines, torque settings, system and tool status alerts, or warnings, and
wherein, after the access control device receives user credentials from the user, the storage device is configured to display the display information in the assigned language corresponding to the user.

5. The automated inventory control system of claim 1, wherein the access control device includes one or more of: an RFID proximity sensor, a magstripe card scanner, a barcode scanner, a camera, or a biometric sensor.

6. The automated inventory control system of claim 2, wherein the data storage stores text strings, audio files, and video files in a plurality of language directories each associated with a different language.

7. The automated inventory control system of claim 1,
wherein the information corresponding to respective users of the storage device further includes an assigned unit of measurement, and
in response to the access control device receiving user credentials from a user, the storage device is configured to obtain configurable parameters from the data storage in the assigned unit of measurement of the information corresponding to the user.

8. The automated inventory control system of claim 1,
wherein the storage device is further configured to obtain configurable parameters from the data storage based on one or more of: a work order associated with the user, one or more tools associated with the work order or with the user, or a second user associated with the user.

9. The automated inventory control system of claim 1, the storage device is one of a tool locker, a tool crib, or a secure storage device.

10. The automated inventory control system of claim 1, further comprising one or more sensing systems configured to detect presence or absence of the objects.

11. The automated inventory control system of claim 10, wherein the one or more sensing systems includes one or more of:
one or more cameras configured to obtain images of the plurality of storage locations,
one or more RF sensors configured to detect RFID tags,
one or more electrical connections configured to connect to respective objects,
one or more scales configured to detect weights of respective objects,
an array of contact sensors configured to detect a shape of an object,
one or more ultrasonic sensors, each comprising an emitter configured to emit sound waves and a detector configured to detect sound waves, or
one or more magnetic inductive sensors configured to detect metallic objects.

12. The automated inventory control system of claim 1, further comprising:
one or more network connections configured to connect the data storage to the storage device and one or more other storage devices,
wherein the data storage is physically remote from one or more of the storage device and the one or more other storage devices, and
wherein the data storage is configured to transmit the configurable parameters in the assigned language corresponding to the user to each of the storage device and the one or more other storage devices.

13. A method for an automated inventory control system, comprising the steps of:
storing an object in a storage location of a storage device;
assigning a language, of a plurality of languages, to a user of the storage device;
storing, in a data storage, configurable parameters associated with the storage device in a plurality of languages, and information corresponding to respective users of the storage device including an assigned language;
receiving, with an access control device, user credentials for access to the storage device;
in response to receiving user credentials of the user, obtaining configurable parameters from the data storage.

14. The method of claim 13, wherein the configurable parameters from the data storage are in the assigned language corresponding to the user.

15. The method of claim 13, further comprising the step of:
displaying, on a display associated with the storage device, display information in the assigned language corresponding to the user,
wherein the display information comprises one or more of: work instructions, tool selection, safety guidelines, torque settings, system and tool status alerts, or warnings.

16. The method of claim 13, further comprising the step of:
receiving, at the storage device, information reflecting one or more of: a work order associated with the user, one or more tools associated with the work order or with the user, or a second user associated with the user, and
obtaining configurable parameters from the data storage based on received information.

17. A non-transitory computer-readable medium storing executable instructions for carrying out a process comprising the steps of:
associating a language, of a plurality of languages, to a user of a storage device;
storing, to a data storage, configurable parameters associated with the storage device in a plurality of languages, and information corresponding to respective users of the storage device including an assigned language;
receiving, from an access control device, user credentials for access to the storage device;
in response to receiving user credentials of the user, obtaining configurable parameters from the data storage.

18. The non-transitory computer-readable medium of claim 17, wherein the configurable parameters from the data storage are in the assigned language corresponding to the user.

19. The non-transitory computer-readable medium of claim 17, the process further comprising the step of:
in response to receiving user credentials of the user, configuring the storage device to display text strings, audio files, and video files, stored in the storage device, according to a language directory associated with the assigned language of the user.

20. The non-transitory computer-readable medium of claim 17, the process further comprising the steps of:
associating a unit of measurement to a user of a storage device;
in response to receiving user credentials of the user, configuring the storage device to display values according the unit of measurement associated with the user.
